(19) United States
(12) Patent Application Publication
(10) Pub. No.: US 2007/0086607 A1
(43) Pub. Date: Apr. 19, 2007

(54) Toy building element comprising a number of parts

(76) Inventors: Henk Hendrik Bernard Holsheimer, Kolding (DK); Maria Rosario Pereira Costa, Vejle (DK); Peter John Grinsell, Vejle (DK)

Correspondence Address: DAY PITNEY LLP, 7 TIMES SQUARE, NEW YORK, NY, 10036-7311, US

(21) Appl. No.: 10/565,130

(22) PCT Filed: Jul. 22, 2004
(86) PCT No.: PCT/DK04/00510

§ 371 Date: Jul. 19, 2006

(30) Foreign Application Priority Data
Jul. 23, 2003 (DK) PA 2003 01100

(51) Int. Cl. H04R 25/00

(52) U.S. Cl. 381/172

(57) ABSTRACT

A toy building element with coupling studs (6) and/or coupling skirts (7) that are complementary therewith for being interconnected with other toy building elements provided with corresponding coupling studs and/or coupling skirts, said interconnection taking place in an axial direction of the coupling studs and/or the coupling skirts. The toy building element comprises a top element (1) and a bottom element (2) that can be interconnected by means of coupling means that are releasable exclusively by rotation about an axis (A) in parallel with the axial direction of the coupling studs (6) and/or the coupling skirts (7). Besides, the toy building comprises at least one intermediate element (8), said top element (1) being interconnectable with an upper end of the intermediate element (8), while the bottom element (2) can be interconnected with a lower end of the intermediate element (8).

The invention relates to a toy building element with coupling studs and/or coupling skirts that are complementary therewith for being interconnected with other toy building elements provided with corresponding coupling studs and/or coupling skirts, the interconnection taking place in the axial direction of the coupling studs and/or coupling skirts, said toy building element comprising a top element and a bottom element that can be interconnected by means of coupling means that are releasable exclusively by rotation about an axis in parallel with the axial direction of the coupling studs and/or coupling skirts.

Such toy building element is known from U.S. Pat. No. 4,103,774 showing a capsule consisting of two half-parts that can be joined by screwing via a threaded coupling. Each half-part is provided with complementary coupling means in the form of coupling studs and coupling skirts. By assembling the two half-parts by means of a threaded coupling it is accomplished that a rotation has to be performed of the half-parts in relation to each other before they can be separated. Since, during play, the toy building element is interconnected with and separated from other toy building elements in the axial direction of the coupling studs, there is no risk of the toy building element being separated into its two half-parts when the toy building elements are separated by a pull being exerted in the axial direction of the coupling studs. Thus, the toy building element can be separated only by a rotation being performed between the individual elements, and such movement will be very unnatural when toy building elements having coupling studs and couplings skirts that are complementary therewith are used for building.

Additionally, WO 01/17634 discloses an egg-shaped container composed of two elements: a top element provided with upwardly protruding coupling studs and a bottom element provided with coupling skirts. The two elements of this toy building element are interconnected by means of a snap coupling between the lower edge of the top element and the upper edge of the bottom element, respectively. The snap coupling is provided by the upper edge of the bottom element being provided with an outwardly projecting bead that is complementary with an interiorly undercut groove provided at the lower edge of the top element. The two elements are so flexible that they can be deformed sufficiently for causing the two edges to snap-lockingly engage with each other. Separation of the two elements occurs by a combination of pull and twist between the two elements, whereby the snap-engagement is released.

The toy building element shown in WO 01/17634 is configured as a container; however, since—in its assembled state—it is provided with both coupling studs and coupling skirts arranged at a particular modular distance, it can also be used decidedly as a toy building element in a toy building set that comprises further toy building elements with coupling studs and coupling skirts arranged at the same modular distance. Thus, the toy building element serves two functions: viz that of a container and that of a toy building element.

Since the two elements of this prior art toy building element are interconnected by a snap-coupling there is, however, an elevated risk of the two elements being separated during play; in particular when the toy building element as a whole is to be separated from other toy building elements with which it was previously interconnected. Therefore, the container does not appear as a solid toy building element; but rather as a toy building element that must be subject to particular attention when it is played with in combination with other toy building elements.

In both of the above-described toy building elements the toy building element consists of a top element and a bottom element. The toy building element can be used by it being used as an assembled toy building element with interconnected top element and bottom element; or the two elements can be used separately. The toy building element does not offer further variations.

It is the object of the present invention to provide a toy building element that provides several options for variation with regard to their construction compared to the prior art toy building elements.

This is accomplished by configuration of the above-mentioned toy building element in such a manner that it further comprises at least one intermediate element, the top element being capable of interconnection with an upper end of the intermediate element, while the bottom element can be interconnected with a lower end of the intermediate element.

The provision of such intermediary element enables variations in the height of the toy building element proportionately with the height of the intermediate element. If a number of intermediate elements are employed, a further increase of the height of the toy building element can be accomplished. As the top element and the bottom element can be coupled directly to each other and also must be capable of interconnection with one or more intermediate elements, the coupling means of the intermediate elements must be complementary with the coupling means of the top element and the bottom element.

The rotatable coupling means can be configured in a number of ways, but preferably they are constituted of a bayonet coupling or a threaded coupling. Such couplings are very reliable and can only be released by a turning of the elements in relation to each other.

According to a preferred embodiment the toy building element comprises a top element and a bottom element, wherein the top element is provided with upwardly protruding coupling studs, while the bottom element is provided with coupling skirts. By means of such elements it is possible to construct entirely conventional toy building elements with upwardly protruding coupling studs and coupling skirts that are complementary therewith.

According to one embodiment the intermediate element is configured as an upwardly open container having a bottom at the lower end. Such Intermediate element can be used as a container or a packaging for other toy building elements that partake in the toy building set as it can be closed by the top element.

The bottom face of the intermediate element can be provided with downwardly protruding coupling studs whereby it is possible to construct a particular toy building element with coupling studs that protrude to opposite sides when interconnected with a top element having upwardly protruding coupling studs.

The invention will now be explained in further detail with reference to the drawing, wherein

FIG. 1 shows a toy building set according to the invention in a first embodiment;

FIG. 2 shows the toy building element shown in FIG. 1 in its separated state and with an additional element;

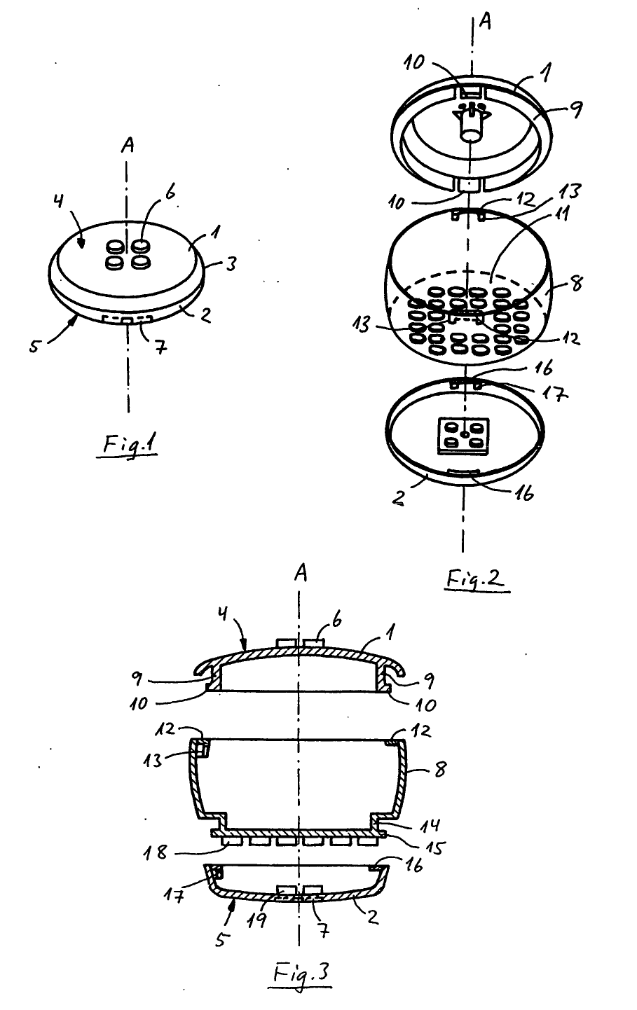

FIG. 3 is a cross-sectional view through the toy building element shown in FIG. 2 in separated state;

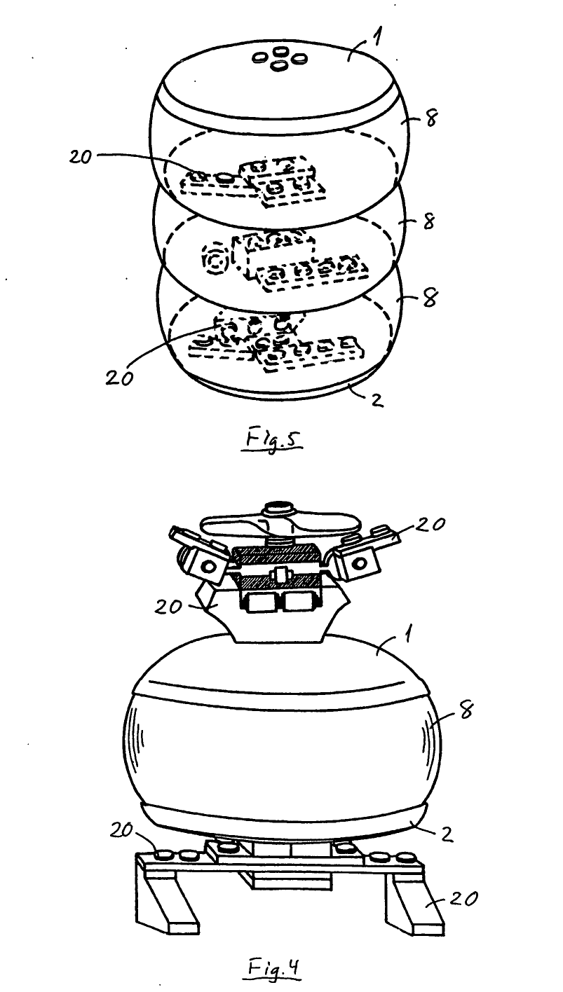

FIG. 4 shows the toy building element shown in FIGS. 2 and 3 in assembled state and interconnected with other toy building elements;

FIG. 5 shows a toy building element according to the invention comprising a number of elements;

FIG. 6 shows an alternative embodiment of a toy building element according to the invention; and

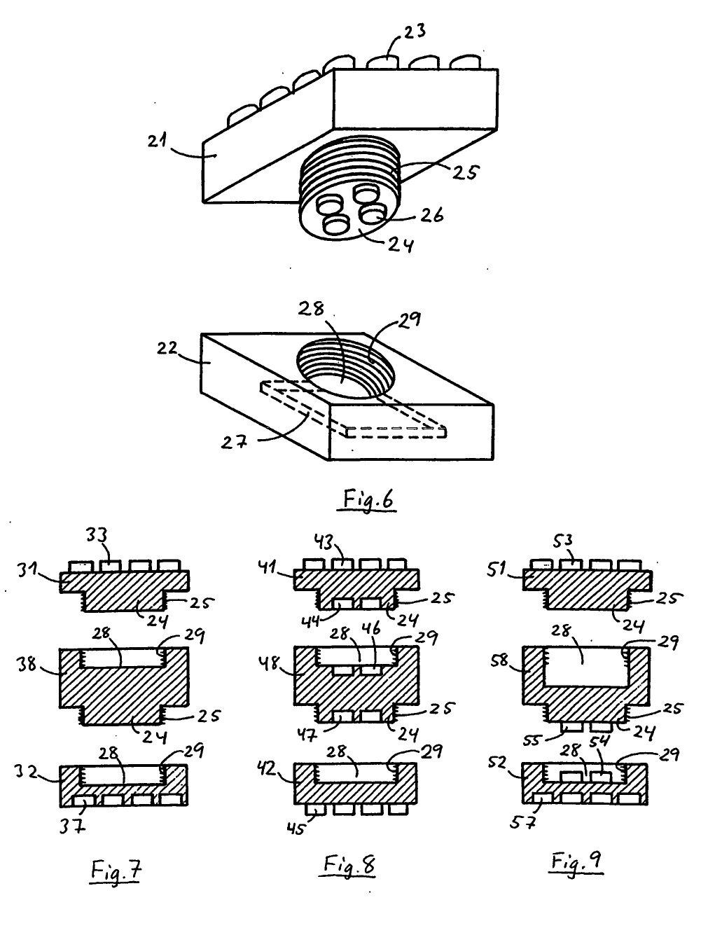

FIGS. 7-9 are explanatory sketches of alternative embodiments of toy building elements configured in accordance with the invention.

FIG. 1 shows a toy building element that comprises only two elements; viz a top element 1 and a bottom element 2. The toy building element has a circular outer periphery 3 and is configured with a relatively flat element having a rounded surface 4 on the top element 1 and a rounded bottom face 5 on the bottom element 2. On the top face 4, the top element 1 is provided with four upwardly protruding coupling studs 6 having an upwardly oriented axial direction and, on the bottom face 5, the bottom element 2 is configured with coupling skirts 7 (outlined by broken lines) that are complementary with the coupling studs 6. Thus, the assembled toy building element corresponds to commonly known toy building elements with coupling studs 6 on the top face 4 and coupling skirts 7 on the bottom face 5 that are complementary therewith. However, the shown toy building element distinguishes itself from the prior art toy building elements in that it consists of two elements that can be separated exclusively by a rotation of the two elements in relation to each other about a central axis A that is in parallel with the axial orientation of the coupling studs 6. This will appear more clearly from FIGS. 2 and 3 that show a toy building element according to the invention and comprising three elements.

FIG. 2 is a perspective view of a toy building set according to the invention in its separated state, and FIG. 3 is a cross-sectional view through the same toy building element—also in separated state. As will appear, this toy building element also comprises a top element 1 and a bottom element 2 being, in the shown embodiment, identical with the top element 1 and the bottom element 2 of the toy building element shown in FIG. 1. Moreover, this toy building element also comprises an intermediate element 8 that can be interconnected with the top element 1 and the bottom element 2 for forming an assembled toy building element (see FIG. 4). Referring to both FIG. 2 and FIG. 3, now follows a more detailed description of how the three elements are Interconnected to form an assembled toy building element.

On its bottom face, the top element 1 is provided with a downwardly oriented annular part 9 situated interiorly of the periphery. In two places this annular part 9 is provided with two outwardly projecting horizontal flaps 10 that each forms an engagement face for use in a bayonet coupling between the top element 1 and the intermediate element 8 or the bottom element 2.

In the shown embodiment the intermediate element 8 is shown as an upwardly open container with a closed bottom 11. At the upper end, the intermediate element 8 is provided with two engagement flanges 12 that project radially inwards from the side edge of the intermediate element 8, and are configured to be complementary with the projecting flaps 10 on the top element 1, whereby these parts combine to form a bayonet coupling. A downwardly oriented wall 13 at the one end of each engagement flange 12 forms a stop element for the flap 10 on the top element 1 when the two elements are interconnected. The lower end of the intermediate element 8 is configured with an annular part 14, from where two horizontal flaps 15 protrude radially (see FIG. 3). The flaps 10 on the top element 1 and the flaps 15 on the intermediate element are configured identically.

At its upper edge the bottom element 2 is provided with two engagement flanges 16 that project radially inwards and are configured to be complementary with the protruding flaps 10 and 15 on the top element 1 and the intermediate element 8, whereby these parts combine to form a bayonet coupling. A downwardly oriented wall 17 at the one end of each engagement flange 16 forms a stop for the flap 10 or 15 when the two elements are interconnected. The engagement flanges 16 on the bottom element 2 and the engagement flanges 12 on the intermediate element 8 are configured identically.

When the toy building element according to the invention is to be constructed from the three shown elements (the top element 1, the bottom element 2 and the intermediate element 8), the flaps 10 on the top element is taken down into the upper opening of the intermediate element 8, following which the top element 1 is turned until the flaps 10 engage with the engagement flanges 12 on the intermediate element 8. The top element 1 is turned until the flaps 10 abut on the wall 13, following which the two elements are interconnected. In a corresponding manner the intermediate element 8 and the bottom element 2 are interconnected by the flaps 15 on the intermediate element 8 being taken down into the cavity of the bottom element 2, following which the intermediate element 8 is turned until the flaps 15 engage with the engagement flanges 16 on the bottom element 2. The intermediate element 8 is turned until the flaps 15 adjoin the wall 17, following which the two elements are interconnected. Preferably a certain friction is provided between the flaps 10, 15 and the engagement flanges 12, 16, meaning that a certain force is to be overcome in order to enable renewed separation of the elements. Some kind of snap locking may also be provided between the flaps 10, 15 and the engagement flanges 12, 16.

The flaps 10 and 15 on the top element 1 and the intermediate element 8, respectively, being identical, and the engagement flanges 12 and 16 on the intermediate element 8 and the bottom element 2, respectively, being identical, it is an option to interconnect all three elements in the shown sequence, or it is an option to merely interconnect the top element 1 and the bottom element 2, whereby the toy building element shown in FIG. 1 is accomplished. It is also an option to merely interconnect the top element 1 and the intermediate element 8 or to interconnect the intermediate element 8 and the bottom element 2. Thus, by the invention it is possible to construct a variety of toy building elements by means of a limited number of elements.

As will appear from FIG. 3, the top element is provided with coupling studs 6 on the top face 4. The intermediate element 8 is configured as an upwardly open container with a bottom 11 being, in the shown embodiment, provided with downwardly projecting coupling studs 18. If a toy building element according to the invention is formed merely by interconnection of the top element 1 and the intermediate element 8, a toy building element is accomplished that has coupling studs on both its top face and its bottom face.

In the shown embodiment, the bottom element 2 is provided with coupling skirts 7 on the bottom face 5 and interiorly with upwardly projecting coupling studs 19. Thus the bottom element 2 can be used alone as an independent toy building element having both coupling studs 19 and coupling skirts 7. If the bottom element 2 is interconnected with the intermediate element 8, a toy building element in the form of a container with coupling skirts on the bottom face is accomplished. If the top element 1 is further coupled with the intermediate element 8, a toy building element is accomplished being, on its top face, provided with coupling studs 6 and, on its bottom face, with coupling skirts 7 and which also serves as a packaging for other toy building elements. A use of such toy building element will appear from FIG. 4, where it is interconnected with other toy building elements 20 provided with coupling studs and coupling skirts as it is commonly known from toy building sets.

Apart from the interconnection of two or three of the elements shown In FIGS. 2 and 3, it is, of course, possible to construct even more comprehensive toy building elements if a number of Intermediate elements 8 are available. An example of this is shown in FIG. 5 that shows a toy building element according to the invention that includes a top element 1, a bottom element 2 and three identical intermediate elements 8. Hereby a tall toy building element is accomplished that also accommodates three separate spaces, each intermediate element 8 being configured as an upwardly open container. Further toy building elements of the toy building set could be contained in these spaces as outlined by broken lines. By means of these few types of elements it is thus possible to interconnect an unlimited number of individual containers or packagings.

FIG. 6 shows an alternative embodiment of a toy building element shown in disassembled state. That toy element comprises only two elements, viz a top element 21 and a bottom element 22. Both the top element 21 and the bottom element 22 have a square cross section, to the effect that a box-like appearance is imparted to the assembled toy building element entirely like that of conventional toy building elements.

On its top face the top element 21 is provided with upwardly projecting coupling studs 23 and on the bottom face a downwardly projecting cylindrical base 24 with external thread 25 is provided. Besides, the base 24 is provided with downwardly projecting coupling studs 26.

On its bottom face the bottom element 22 is provided with a coupling skirt 27 (outlined by broken lines) and on its top face a cylindrical indentation 28 with internal thread 29 is provided, which thread is complementary with the external thread 25 on the base 24.

The top element 21 and the bottom element 22 can of course be used as separate toy building elements, the top element 21 being a special element with coupling studs 23, 26 on both the top face and the bottom face. However, the two elements can also be used in combination, the base 24 of the top element 21 fitting into the indentation 28 of the bottom element 22, whereby it is possible to construct an entirely new toy building element. When the top element 21 and the bottom element 22 are to be joined, the base 24 is screwed into the indentation 28 and a stop element (not shown) is preferably provided that makes sure that the side faces of the top element 21 and the bottom element 22 are in parallel when the two elements are completely screwed home.

Further embodiments of elements for constructing a toy building element according to the invention are shown in FIGS. 7-9 that are explanatory sketches of alternative embodiments. In all of the examples the connecting means consist of internal and external threads as shown in the toy building element of FIG. 6, but it will be understood that other rotatable interconnecting means can be used (eg bayonet coupling as shown in FIGS. 2 and 3). In all of the examples three elements are shown (top element, bottom element and intermediate element), but due to the standardised configuration of the coupling means some of the elements may be expendable and, likewise, additional elements could partake in the construction of a toy building element according to the invention. As the interconnecting means correspond to those used in the embodiment shown in FIG. 6, the same reference numerals will be used for base 24, external thread 25, indentation 28 and internal thread 29, respectively.

FIG. 7 shows the simplest form of elements by which conventional toy building elements can be constructed, featuring coupling studs on the top face and coupling skirts on the bottom face. The top element 31 is provided with upwardly protruding coupling studs 33 and the bottom element 32 is configured with coupling skirts 37 at the bottom. It will also appear that the base 24 of the top element 31 is provided with an external thread 25, while the indentation 28 of the bottom element 32 is provided with an internal thread 29. The top element 31 could be interconnected directly to the bottom element 32 for forming a comparatively low toy building element. If a higher toy building element is desired, an intermediate element 38 with corresponding base 24 and indentation 28 could be mounted between top element 31 and bottom element 32. The assembled toy building element will still appear as a conventional toy building element with upwardly projecting coupling studs 33 and coupling skirts 37.

FIG. 8 shows all three elements with a more complex configuration which provides further options when it comes to the construction of a different toy building elements according to the invention. Here the top element 41 is provided with both upwardly projecting coupling studs 43 and coupling skirts 44 and it could thus be used alone like a conventional toy building element. The bottom element 42 is provided with downwardly projecting coupling studs 45, which yields entirely new structural possibilities, in particular if interconnected with the top element 41, as an assembled toy building element is hereby accomplished that has oppositely oriented coupling studs 43, 45. The shown element 48 is configured with coupling skirts 46, 47 on both the top face and the bottom face.

Finally FIG. 9 shows a top element 51 provided with upwardly projecting coupling studs 53. The bottom element 52 is provided with both upwardly oriented coupling studs 54 and coupling skirts 57. The intermediate element is configured to be upwardly open and is moreover provided with downwardly projecting coupling studs 55. In principle, these three elements correspond to the elements shown in FIGS. 2 and 3, the most essential difference being the configuration of the coupling means and the overall configuration of the elements.

The invention was described with reference to various embodiments of the construction of a toy building element. It is readily acknowledged that the various elements that partake In such toy building element could be configured in infinitely many ways; it being of importance, however, that they are interconnected in such a manner as to be released only by a turning movement of the elements in relation to each other.

1. A toy building element with coupling studs (6; 23; 33; 43; 45; 63) and/or skirts (7; 27; 37; 57) that are complementary therewith for interconnection with other toy building elements provided with corresponding coupling studs and/or coupling skirts, the interconnection taking place in the axial direction of the coupling studs and/or coupling skirts, said toy building element comprising a top element (1; 21; 31; 41; 51) and a bottom element (2; 22; 32; 42; 52) that can be interconnected by means of integral coupling means that are releasable exclusively by rotation about an axis (A) in parallel with the axial direction of the coupling studs (6; 23; 33; 43; 45; 53) and/or the coupling skirts (7; 27; 37; 57), characterised in that the toy building element further comprises at least one intermediate element (8; 38; 48; 58), said top element (1; 21; 31; 41; 51) being interconnectable with an upper end of the intermediate element (8; 38; 48; 58), while the bottom element (2; 22; 32; 42; 52) can be interconnected with a lower end of the intermediate element (8; 38; 48; 58).

2. A toy building element according to claim 1, characterised in that the coupling means are a bayonet coupling (10, 12, 15, 16).

3. A toy building means according to claim 1, characterised in that the coupling means are a threaded coupling (25, 29).

4. A toy building element according to claim 1, characterised in that the top element is provided with upwardly projecting coupling studs (6; 23; 33; 43; 53), while the bottom element is provided with coupling skirts (7; 27; 37; 57).

5. A toy building element according to claim 1, characterised in that the intermediate element (8; 58) is configured as an upwardly open container with a bottom (11) at its lower end.

6. A toy building element according to claim 5, characterised in that the bottom (11) on the bottom face (5) is provided with downwardly projecting coupling studs (18; 55).
